(19) United States
(12) Patent Application Publication
(10) Pub. No.: US 2018/0290634 A1
(43) Pub. Date: Oct. 11, 2018

(54) HEAVY VEHICLE LIFTING APPARATUS AND METHOD

(71) Applicant: 3991814 CANADA INC., Québec (CA)

(72) Inventors: Christian BELLEY, Quebec (CA); Robin BELLEY, Quebec (CA)

(21) Appl. No.: 15/527,111

(22) PCT Filed: Dec. 1, 2015
(86) PCT No.: PCT/CA2015/051254

§ 371 Date: May 16, 2017

Related U.S. Application Data
(60) Provisional application No. 62/085,675, filed on Dec. 1, 2014.
(60) Provisional application No. 62/166,162, filed on May 26, 2015.

(51) Int. Cl. B60S 9/10; B66F 3/26; B66F 5/04; B66F 3/46

(52) U.S. Cl. CPC B60S 9/10; B66F 3/46; B66F 5/04; B66F 3/26

(57) ABSTRACT

A heavy vehicle lifting apparatus and a hydraulic lifting unit. Each lifting unit has a housing with a displaceable upper portion which has an application surface being engageable with a lifting point of the heavy vehicle. Two or more hydraulic actuators are disposed within the housing and linked with a common fixed structure. Each actuator has an extendable cylinder attached to the upper portion. The cylinders in operation collectively vertically displace the upper portion and the application surface between a first position wherein the application surface is disengaged from the lifting point, and a second position wherein the application surface engages the lifting point and the heavy vehicle is lifted from a ground surface.

### CROSS-REFERENCE TO RELATED APPLICATIONS

This application claims priority to U.S. provisional patent application having Ser. No. 62/166,162 and filed on May 26, 2015, as well as to U.S. provisional patent application having Ser. No. 62/085,675 and filed on Dec. 1, 2014. The entire contents of these applications are hereby incorporated by reference.

### TECHNICAL FIELD

The application relates generally to raising equipment and, more particularly, to a method and apparatus for lifting heavy vehicles.

### BACKGROUND OF THE ART

Routine maintenance often requires that vehicles such as bulldozers, excavators, haul trucks, and transport trucks be raised in elevation. This allows maintenance crews to access under the equipment so as to perform inspection, maintenance and repairs of the undercarriage.

Consider the example of a bulldozer which uses continuous track motion to displace itself. In order to repair, inspect, or replace the lower components of the bulldozer such as its tracks, or the rollers which turn the tracks, it is usually necessary to raise the bulldozer from the ground.

Conventional techniques for raising the bulldozer use jacks positioned under the bulldozer in select locations. Raising the entire bulldozer in this way is certainly possible, but poses safety risks. The lifting area is relatively compact in comparison to the size of bulldozer, and raising just the lifting area can affect the lateral and longitudinal stability of the entire raised bulldozer. It may therefore be necessary to compensate for instability issues.

Furthermore, caution dictates that the jacks must be secured when they are extended and holding the bulldozer. This is performed using mechanical locking systems which prevent the cylinder of a jack from descending in the event that the jack fails. One type of mechanical locking system involves a lock nut which engages with a thread on the cylinder and prevents a downward displacement of the cylinder against the thread. This works well in a clean, factory-like setting, but is of little use in the field or when the bulldozer is dirty. The dirt and grit of the bulldozer, or projections of high velocity particles due to nearby maintenance activities, can affect the engagement of the lock nut with the threaded rod.

Another type of mechanical locking system involves manually placing locking collars on the vertically extended jacks. This requires an operator to go underneath the raised bulldozer to manually apply the locking collars, which should be avoided if possible for safety reasons.

### SUMMARY

In one aspect, there is provided a heavy vehicle lifting apparatus, comprising: a plurality of hydraulic lifting units each being positionable underneath a lifting point of the heavy vehicle and comprising: a housing having a displaceable upper portion with an application surface being engageable with the lifting point; and at least two hydraulic actuators disposed within the housing and linked with a common fixed structure, each actuator having an extendable cylinder attached to the upper portion, the cylinders in operation collectively vertically displacing the upper portion and the application surface between a first position wherein the application surface is disengaged from the lifting point, and a second position wherein the application surface engages the lifting point and the heavy vehicle is lifted from a ground surface.

In another aspect, there is provided a hydraulic lifting unit positionable underneath a lifting point of a heavy vehicle, comprising: a housing having a displaceable upper portion with an application surface being engageable with the lifting point; and at least two hydraulic actuators disposed within the housing and linked with a common fixed structure, each actuator having an extendable cylinder attached to the upper portion, the cylinders in operation collectively vertically displacing the upper portion and the application surface between a first position wherein the application surface is disengaged from the lifting point, and a second position wherein the application surface engages the lifting point and the heavy vehicle is lifted from a ground surface.

In a further aspect, there is provided a method for lifting a heavy vehicle having lifting points from a ground surface, comprising: positioning each of a plurality of hydraulic lifting units underneath one of the lifting points, each lifting unit having a common application surface being vertically displaceable by at least two extendible cylinders; vertically extending the common application surface with the cylinders; and abutting the common application surface against the lifting point and applying a lifting force thereto to displace the vehicle upward from the ground surface.

### DESCRIPTION OF THE DRAWINGS

Reference is now made to the accompanying figures in which:

FIG. 1A is a plan view of a heavy vehicle lifting apparatus positioned underneath a heavy vehicle, according to an embodiment of the present disclosure.

FIG. 1B is a perspective view of the apparatus of FIG. 1A positioned underneath another type of heavy vehicle, and showing an arrangement of lifting units of the apparatus.

FIG. 2A is a perspective view of one of the lifting units of FIG. 1B;

FIG. 2B is a perspective view of the lifting unit of FIG. 2A, shown in an extended position;

FIG. 2C is a perspective view of a lower portion of the lifting unit of FIG. 2A;

FIG. 3A is a perspective view of two of the lifting units of FIG. 1B, shown connected together with a linking beam;

FIG. 3B is a perspective view of the linking beam of FIG. 3A;

FIG. 4 is a perspective view of another one of the lifting units of FIG. 1B;

FIG. 5 is a partial cross-sectional view of part of a lifting unit having a distance sensor, according to another embodiment of the present disclosure;

FIG. 6A is an exemplary embodiment of a controller of the apparatus, embodied on a computer;

FIG. 6B is an exemplary embodiment of the controller of the apparatus, embodied in a PLC;

FIG. 7A is a rear view of the heavy vehicle of FIG. 1A shown lifted from a ground surface; and

FIG. 7B is a side view of the heave vehicle of FIG. 1A shown lifted from a ground surface.

### DETAILED DESCRIPTION

There is described herein an apparatus used to lift or raise displaceable equipment and more particularly heavy vehicles. The apparatus coordinates the lifting of the vehicles so that it can be raised with respect to a ground surface. In so doing, the apparatus provides clearance so that inspection and maintenance crews can access the lower ends of the vehicle, and suspends the vehicle at an elevation while the maintenance operation is being performed.

The heavy vehicle can be any type of large-tonnage vehicle. The term “heavy vehicle” may be understood in the art as referring to any vehicle whose gross vehicle weight rating (GVWR) exceeds a certain threshold. The heavy vehicle can be any one of a large-capacity excavator, transport truck, mining truck, mining drill, grader, bulldozer, or other similar vehicle. The descriptor “large capacity” refers to a displaceable vehicle 50 with large payloads. For example, the nominal payload capacity of the Caterpillar™ model 797F mining truck is about 400 tons. The vehicles discussed herein include those which can be displaced using their own source of motive power. Irrespective of the type of vehicle used, the vehicle has lifting points against which a lifting force can be applied to lift the vehicle.

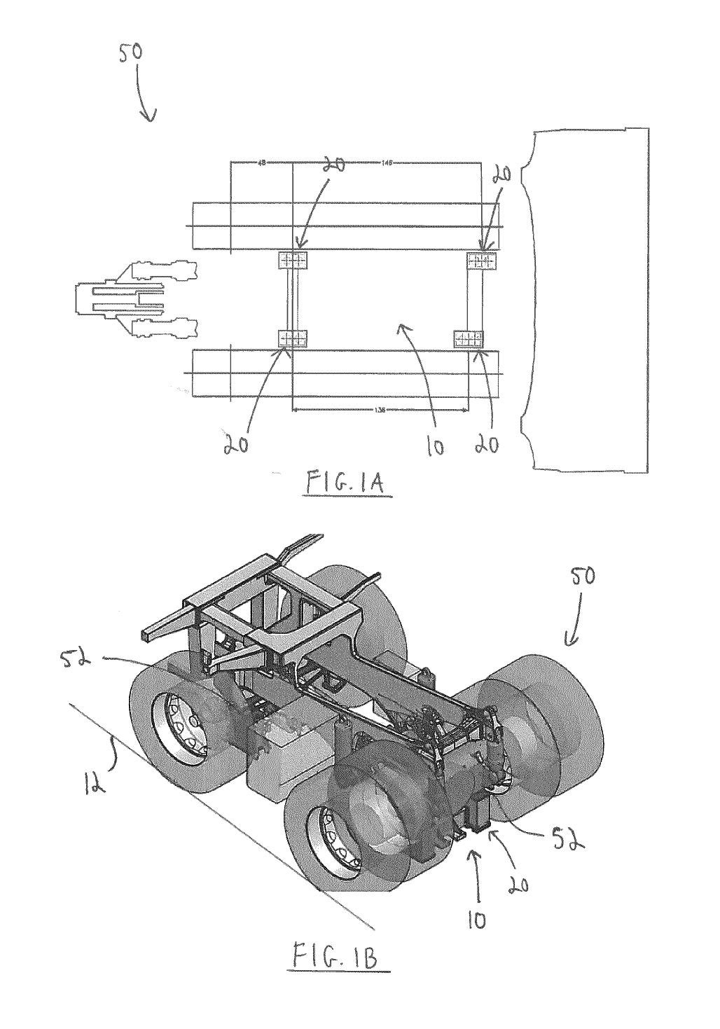

FIGS. 1A and 1B provide examples of such vehicles 50. More particularly, FIG. 1A illustrates a bulldozer, whereas FIG. 1B shows a mining truck. Both vehicles 50 have multiple lifting points 52, which are locations on the vehicle 50 which can support the lifting force used to lift the vehicle 50. The lifting points 52 are generally provided or suggested by the manufacturer of the vehicle 50.

A heavy vehicle lifting apparatus 10 operates to displace or lift the vehicle 50 from a ground surface 12, thereby allowing access underneath the vehicle 50 for inspection, maintenance, or repair. As will be discussed herein in greater detail, the heavy vehicle lifting apparatus 10 (or simply “apparatus 10”) enables a stable lifting operation which can resist or overcome loads or impacts which might destabilize the vehicle 50 when it is lifted from the ground surface 12. The apparatus 10 also allows the lifting operation to be performed without requiring a person to secure the vehicle 50 in the lifted position, thereby improving safety.

The apparatus 10 includes multiple hydraulic lifting units 20 spaced apart underneath the vehicle 50 for lifting same. The lifting units 20 are actuated by a hydraulic fluid, typically oil, and are responsible for applying a lifting force to displace the vehicle 50 vertically upward. In so doing, the lifting units 20 lift the entirety of the vehicle 50 from the ground surface 12. Each lifting unit 20 can therefore take any form or configuration capable of such functionality, some of which are discussed below.

FIG. 1A illustrates a possible configuration of the lifting units 20 with respect to the vehicle 50. Four lifting units 20 are provided, and arranged in spaced apart pairs. A first pair of lifting units 20 is placed towards the front of the vehicle 50 (i.e. near the blade of the bulldozer), while a second pair of lifting units 20 are placed towards the rear of the vehicle 50. Such an arrangement of the lifting units 20 can improve the lateral and longitudinal stability of the vehicle 50 when raised from the ground surface. It will be appreciated that more or fewer lifting units 20 can also be used. For example, three lifting units 20 may be positioned underneath the vehicle 50 in a triangular configuration and spaced 120° from one another.

Each lifting unit 20 is positioned underneath one of the lifting points 52 so that, when in operation, a component of each lifting unit 20 vertically extends upward to abut against the corresponding lifting point 52. Each lifting unit 20 can be abutted directly against the lifting point 52, or indirectly via intermediary components such as shims. When it enters into contact with the lifting point 52, each lifting unit applies a lifting force to each of the lifting points 52. The collective application of lifting forces operates to displace the vehicle 50 upward from the ground surface 12.

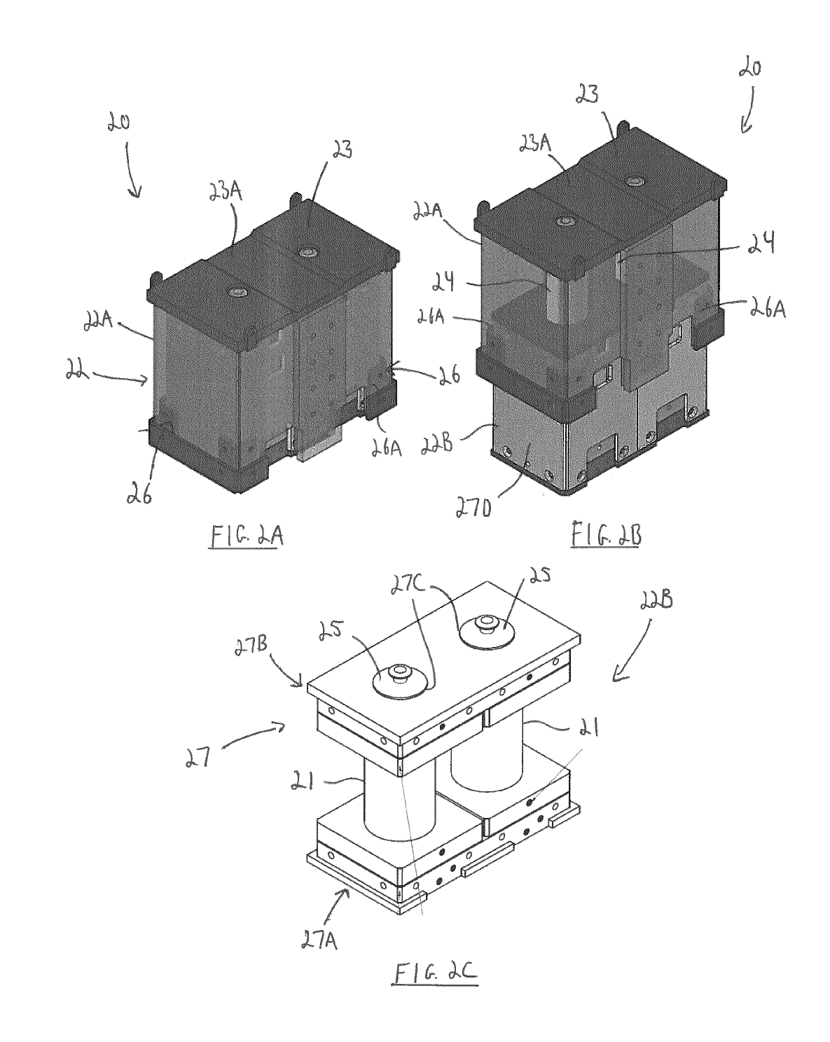

Referring to FIGS. 2A to 2C, each of the lifting units 20 has two or more actuators 21 contained within a housing 22. The actuators 21 are structurally linked but may be hydraulically independent. Each actuator 21 has an extendable piston rod or cylinder 24 which extends upward. A distal head 25 of each cylinder 24 imparts a vertical lifting force onto part of the housing 22.

The housing 22 forms the corpus of each lifting unit 20 and provides structure thereto. The housing 22 consists of an upper portion 22A which is displaced upward by the vertical extension of the cylinders 24. An application surface 23, which is an exposed upper surface of the upper portion 22A, is displaced upward with the upper portion 22A and engages each lifting point to provide the lifting force thereto. The application surface 23 is a substantially planar surface. In the embodiment shown, the application surface 23 has a grooved portion 23A therein. The grooved portion 23A can help to confine the contours of the vehicle's lifting point when the application surface 23 is abutted thereagainst. The groove portion 23A can also receive correspondingly-shaped shims, which lie therein and are confined thereby.

In the embodiment shown, the housing 22 also has a lower portion 22B which remains stationary. The lower portion 22B houses the actuators 21 and their cylinders 24, which are vertically extended relative to the lower portion 22B. The upper portion 22A is mounted about the lower portion 22B and is displaced relative to the lower portion 22B, as shown in FIG. 2B. More particularly, as the heads 25 of each cylinder 24 are extended, the upper portion 22A moves vertically relative to the stationary lower portion 22B. As shown in FIGS. 2A and 2B, each of the upper and lower portions 22A,22B can have a suitable casing. The casings of the upper and lower portions 22A,22B provides an external rigid structure which supports the relative displacement of the upper and lower portions 22A,22B. The casings also help to protect the components thereof, and to prevent ingress of dirt or debris.

Referring to FIGS. 2A and 2B, the displacement of the upper portion 22A relative to the lower portion 22B may be guided. Such a guided relative displacement facilitates a smooth and stable lifting operation. Many configurations are possible to effect this guided displacement. In the embodiment shown, the housing 22 has one or more displacement guides 26 which are disposed between an interior of the upper portion 22A and an exterior of the lower portion 22B. The displacement guides 26 can include a liner, bearing, or other low friction arrangement. In the embodiment shown, the displacement guide 26 includes a plurality of guidance plates 26A. Each guidance plate 26A is attached to the interior of the upper portion 22A and abuts against the exterior of the lower portion 22B. When the upper portion 22A is displaced relative to the lower portion 22B, the guidance plates 26A prevent the upper portion 22A from deviating substantially from the desired displacement path by engaging with the exterior of the lower portion 22B. To reduce friction, one or more the guidance plates 26A can be lubricated, or be made of a material that has a low coefficient of friction, such as bronze oilite.

The cylinders 24 of the at least two actuators 21 contained within each housing 22 extend vertically upward. The head 25 of the each cylinder 24 is attached to the upper portion 22A of the housing 22. When they extend, each cylinder 24 therefore displaces the upper portion 22A and its application surface 23 upward relative to the lower portion 22B. The application surface 23 abuts against a lifting point of the vehicle and applies the lifting force thereto.

The cylinders 24 therefore collectively displace the upper portion 22A and its application surface 23 between a first position and a second position. In the first position, the application surface 23 does not abut against the lifting point and is disengaged therefrom. The first position can therefore be any position of the upper portion 22A where it is underneath the lifting point and not applying a lifting force thereto, such as when the cylinders 24 are not extended as shown in FIG. 2A. In the second position, the application surface 23 engages the lifting point and the heavy vehicle is lifted from the ground surface. The second position can therefore be any position of the upper portion 22A where it is underneath the lifting point and applies the lifting force thereto, such as when the cylinders 24 are fully extended as shown in FIG. 2B.

It can thus be appreciated that the multiple cylinders 24 of each lifting unit 20 cooperate together to apply one force output (i.e. a collective lifting force) which is channelled through a single point or plane of contact (e.g. the application surface 23) against the lifting point. This configuration simplifies the lifting operation and improves the safety of the lifting operation. More particularly, the use of two cylinders 24 provides redundancy to the apparatus, thereby increasing its safety and reliability. For example, if one of the two cylinders 24 were to fail, the remaining cylinder 24 would be able to satisfy the load requirements of that lifting unit 20. Furthermore, since both cylinders 24 abut against the same application surface 23 and are linked thereby, the force output to the lifting point of the vehicle will not change substantially because the remaining cylinder 24 can still apply the lifting force to the same application surface 23.

The actuators 21 disposed within the housing 22 are linked with a common fixed structure 27. The common fixed structure 27 encases and guides displacement of the cylinders 24, and reinforces them against lateral loads which may case instability. The common fixed structure 27 therefore structurally links the actuators 21 together, and with the housing 22.

In the embodiment of FIG. 2C, the common fixed structure 27 includes a base plate assembly 27A which supports each actuator 21 at its base and provides a platform against which each actuator 21 can apply the lifting force. The base plate assembly 27A can include hydraulic ports for feeding the hydraulic fluid to the actuators 21. The common fixed structure 27 also has an upper plate assembly 27B which is spaced upwardly from the base plate assembly 27A. The upper plate assembly 27B reinforces the actuators 21 along an upper portion thereof. The upper plate assembly 27B contains openings 27C which allow the cylinders 24 to extend through the upper plate assembly 27B to displace the upper portion. Both the lower and upper plate assemblies 27A,27B are attached to a casing 27D of the lower portion 22B which can be made of assembled wall plates, thereby forming the common fixed structure 27 of plate assemblies 27A,27B, actuators 21, and casing 27D.

In the event that one of the actuators 21 fails and its cylinder 24 does not extend, the upper plate assembly 27B will constrain the functional actuator 21 in place and ensure that its cylinder 24 is still able to support the upper portion. Furthermore, the common fixed structure 27 formed by the plate assemblies 27A,27B, actuators 21, and casing 27D is better able to resist lateral loads which may result from side impacts on the raised vehicle due to moving equipment.

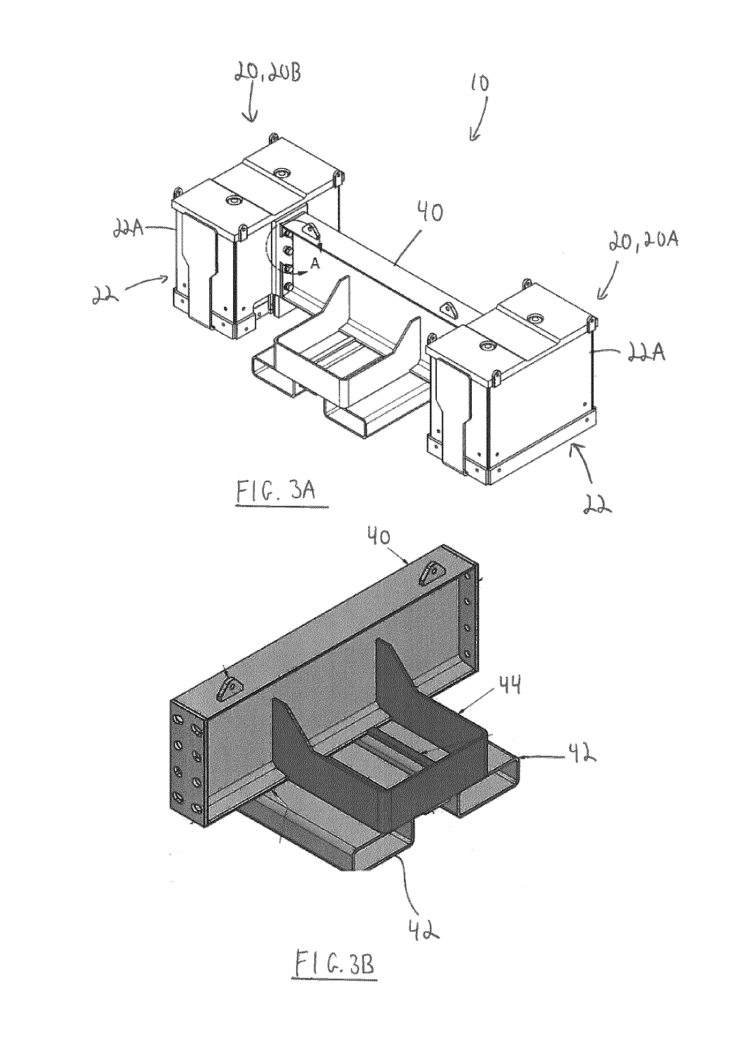

Referring to FIGS. 3A and 3B, the apparatus 10 may have one or more linking structures or beams 40. Each linking beam 40 structurally links together two or more spaced apart lifting units 20. In most instances, the linking beam 40 is connected to the upper portion 22A of the housing 22 so as to be displaced vertically therewith as the cylinders are vertically extended. In the embodiment shown, one linking beam 40 extends between and connects the upper portions 22A of two lifting units 20, but it will be appreciated that the linking beam 40 can connect more lifting units 20. The apparatus 10 may also include separate linking structures 40, each one linking together two of the lifting units 20. Alternatively, the apparatus 10 can include a single linking beam 40 linking together all of the lifting units 20 in the apparatus 10. According to one embodiment, only one linking beam 40 is provided between the rear lifting units and no linking beam 40 is provided between the front lifting units. This configuration may be desirable for vehicles where most of its mass is concentrated in the rear of the vehicle, or where it is desired to give access to underneath the vehicle via its front. The linking beam 40 can be any beam, frame, shaft or other similar object, made from any suitable material.

Each linking beam 40 reinforces the stability of the apparatus 10 by supporting the apparatus 10 and the lifting operation against lateral forces. The lateral forces are those that act against the vehicle during the lifting operation and risk to displace it towards its left and right sides. Some examples of these lateral forces include a mobile vehicle (e.g. a forklift) or moving load bumping into the vehicle in its raised configuration, and the loads created when the track of the vehicle is run while it is lifted from the ground. The linking beam 40 helps to distribute these lateral loads more evenly amongst the lifting units 20, thereby reducing the likelihood that they will disrupt the supported load.

Referring to FIG. 3B, the linking beam 40 can include support conduits 42 mounted thereto. Each support conduit 42 can be hollow to receive therein a lift member of a truck lift or pallet lift, such as the fork of a forklift or pallet truck. The support conduits 42 therefore allow the lifting beam 40, and thus the lifting units attached thereto, to be easily moved. The lifting beam 40 may also have a barrier 44 or bumper to protect it from impacts by other vehicles.

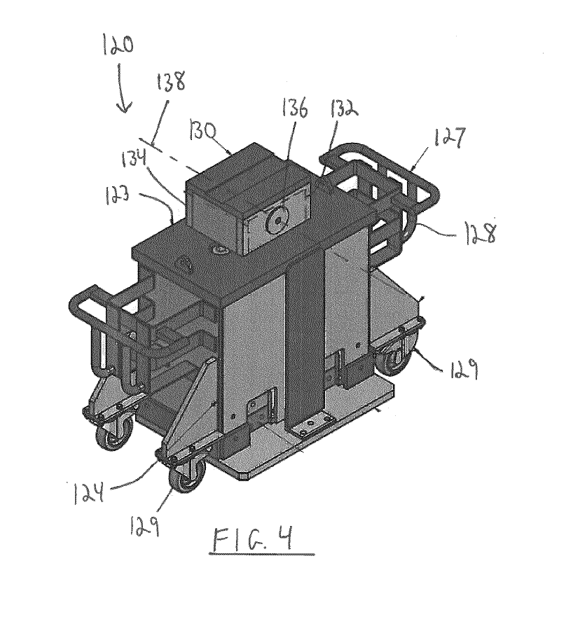

FIG. 4 provides another example of a lifting unit 120. The lifting unit 120 includes a spacer box 130 mounted to the application surface 123 and displaceable therewith to engage a corresponding lifting point of the heavy vehicle. The spacer box 130 increases the overall height the lifting unit 120, and thus brings the lifting unit 120 closer to a lifting point on the vehicle. The spacer box 130 may be used for those lifting points on the vehicle which are more elevated, and thus further away from the ground surface. This can be the case with the lifting points at the front of the vehicle, for example.

The spacer box 130 can be pivotally mounted to the application surface 123 such that it can pivot relative to the application surface 123. The ability of the spacer box 130 to pivot allows its uppermost surface to accommodate and match the orientation of the surface of the lifting point against which it abuts. This helps the lifting unit 120 to conform to the surface against which it applies the lifting force. In the embodiment shown, the spacer box 130 has an inner housing 132 mounted to the application surface 123, and an outer housing 134 pivotably mounted to the inner housing 132. A pivot rod 136 connects the inner and outer housings 132,134. The outer housing 134 pivots with the pivot rod 136 about the inner housing 132 in response to the outer housing 134 engaging the lifting point of the vehicle. The pivot rod 136 extends along a pivot rod axis 138 which is perpendicular to a center axis of each cylinder. The pivot axis 138 is disposed equidistantly between the center axes of the cylinders. This disposition of the pivot axis 138 helps to ensure that it is centrally located on the lifting unit 120 such that the load supported by the spacer box 130 is evenly distributed among the cylinders.

The lifting unit 120 of FIG. 4 is also displaceable, such as with wheels 129. The wheels 129 can be mounted to the upper portion 124 of the lifting unit 120. As the upper portion 124 of the lifting unit 120 is raised, so too are the wheels 129. The lifting unit 120 can also have a handle 127. The handle 127 allows the stacking and storage of spacer plates therein, and has a multi-level frame structure 128 which can receive the forks of a forklift in order to lift and displace the lifting unit 120.

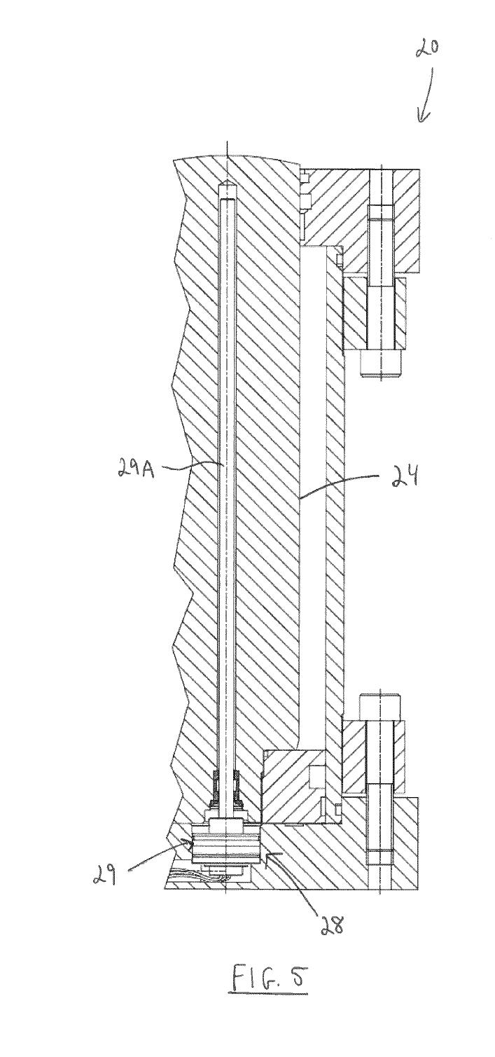

Referring to FIG. 5, the vertical extension of each cylinder 24 can be monitored using any appropriate sensor, such as a distance sensor 28. This information can be outputted to a controller or other information management device, so as to coordinate and synchronize the vertical extension of each cylinder 24 of the lifting units 20. The cylinders 24 of some lifting units 20 may consequently need to extend more or less in order to establish the desired lifting reference plane, maintain the lifting operation level (i.e parallel to the lifting reference plane), or achieve any desired predetermined length of extension.

The distance sensor 28 may measure the distance that a given cylinder 24 has risen with respect to an initial position. One example of a suitable distance sensor 28 is a transducer 29. The transducer 29 has a transducer rod 29A placed within the body of the cylinder 24 and fixed to a base of the lifting unit 20. As the cylinder 24 is extended upward, a magnetic pick up tracks the displacement of the cylinder 24 relative to the transducer rod 29A fixed in place, and converts this into a measurement which can be sent to the controller. The measured distance can be compared to that of the lifting unit 20 linked to this cylinder 24 by the linkage beam to maintain a level lifting operation. Once all of the cylinders 24 have reached the predetermined length, the vertical extension can cease and the lifting operation ceases. The distance sensors 28 may communicate with the controller so that it can track the progress of the lifting units 20. It can thus be appreciated that the distance sensors 28 help to synchronise the operation of the cylinders 24 of each lifting unit 20, and can provide continuous position feedback to the controller. With such an arrangement, it may not be required to physically interconnect the lifting units 20 with the linking beam. Furthermore, since the transducer 29 is located within each cylinder 24, it will not be exposed to the elements and dirt of its environment, thereby improving the reliability of the apparatus 10.

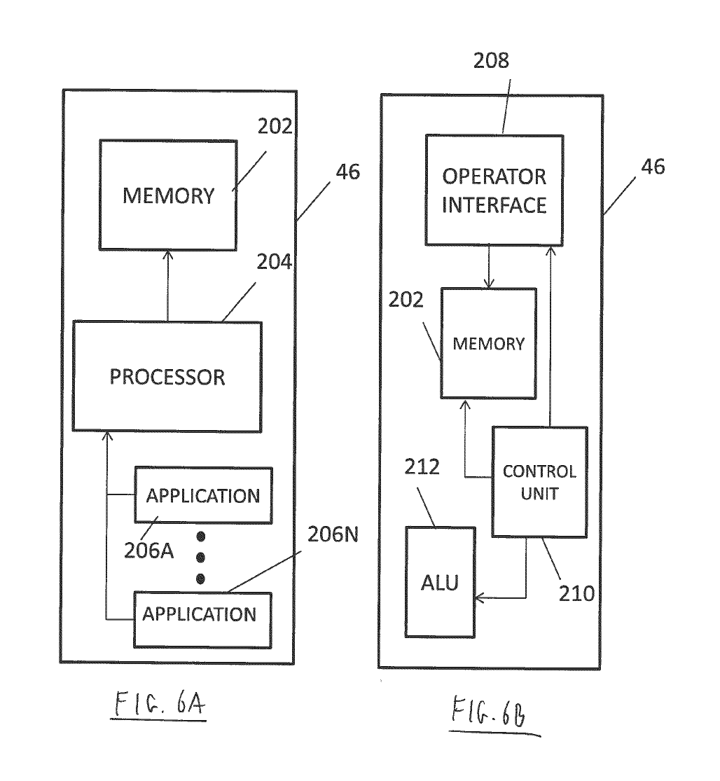

Referring to FIGS. 6A and 6B, and as previously discussed, the apparatus 10 may also comprise a controller 46 which communicates commands to one or more of the components of the apparatus and may also receive feedback therefrom. More particularly, the controller 46 communicates with one or more of the lifting units. The controller 46 sends lift signals to one or more of the lifting units to command them to vertically extend their cylinders and effect the lifting operation.

The controller 46 can also send hold signals to command the lifting units and/or their cylinders to cease displacing the vehicle, and thus, cease lifting the vehicle as a whole. The length at which the cylinders are stopped is their extension length, which may or may not correspond to the predetermined length. The controller 46 sends the hold signals generally when the cylinders are vertically extended to the predetermined length. Once the cylinders have each extended to the predetermined length, the lifting operation has been achieved and it is no longer necessary to continue lifting. In such a case, the extension length of each cylinder corresponds to the predetermined length. The cylinders may therefore signal the controller 46 that the desired height has been achieved, and the controller 46 may respond with the hold signals instructing the cylinders to cease vertically extending.

It will be appreciated that the controller 46 can send other signals as well. For example, the controller 46 can send a predetermined length input signal to each of the lifting units, actuating their cylinders to exert the lifting force required to extend to the predetermined length. Other such signals are also within the scope of the present disclosure.

The controller 46 can take many different physical forms. FIG. 6A is an exemplary embodiment of the controller 46, which may comprise, amongst other things, a plurality of applications 206a . . . 206n running on a processor 204 coupled to a memory 202. One such application may be configured for lifting the vehicle. It should be understood that while the applications 206a . . . 206n presented herein are illustrated and described as separate entities, they may be combined or separated in a variety of ways.

The memory 202 accessible by the processor 204 may receive and store data, such as but not limited to extension lengths of the lifting units, forces to be applied, and force distribution among the lifting units. The memory 202 may be a main memory, such as a high speed Random Access Memory (RAM), or an auxiliary storage unit, such as a hard disk, a floppy disk, or a magnetic tape drive. The memory 202 may be any other type of memory, such as a Read-Only Memory (ROM), flash memory, or optical storage media such as a videodisc and a compact disc. The processor 204 may access the memory 202 to retrieve data. The processor 204 may be any device that can perform operations on data. Examples are a central processing unit (CPU), a front-end processor, a microprocessor, and a network processor. The applications 206a . . . 206n are coupled to the processor 204 and configured to perform various tasks.

In an alternative embodiment, the controller 46 may comprise an industrial control system, such as a distributed control system (DCS) or a programmable logic controller (PLC). An example is illustrated in FIG. 6B, where the controller 46 comprises an operator interface 208, a memory 202, a control unit 210, and an arithmetic-logic unit (ALU) 212. PLC programs may be downloaded onto the memory 202 via an input port (not shown) such as Ethernet, RS-232, RS-485, or RS-422. In some embodiments, the PLC programs may also be provided through a programming board which writes the program into a memory 202 in the form of a removable chip such as an Electrically Erasable Programmable Read-Only Memory (EEPROM) or an Erasable Programmable Read-Only Memory (EPROM). The control unit 210 selects and calls up instructions from the memory 202 in appropriate sequence and relays the proper commands. Other embodiments are also feasible for the controller 46, such as Programmable Logic Relays (PLR), electronic boards with microcontrollers, and other such devices.

In some embodiments, the controller 46 comprises one or more control panels, each having its own PLC. For example, a first control panel may communicate with, and receive feedback from, the lifting units. A second control panel may also be in communication with the first control panel to receive commands based on the movement of the lifting units. An operator can input variables into one or more of the control panels via the operator interface 208. These input values can be, for example, the lifting force to apply with the lifting units, and/or the predetermined length of the cylinders. In some embodiments, the operator may manually select one of the lifting units and input a predetermined height or a force, respectively, to be applied. The inputs may be provided as any integer value or selected from a list or a drop-down menu. Appropriate hydraulic and electronic cabling can extend to and from the lifting units and the control panels. Alternatively, the controller 46 may communicate with the apparatus wirelessly, via any sort of network such as the Internet, a cellular network, Wi-Fi, or others known to those skilled in the art.

In some embodiments, the controller 46 is configured to be accessible from any one of a plurality of devices, such as a laptop computer, a personal digital assistant (PDA), a smartphone, or the like, adapted to communicate over the network. Alternatively, the controller 46 may be provided in part or in its entirety directly on the devices, as a native application or a web application. It should be understood that cloud computing may also be used such that the controller 46 is provided partially or entirely in the cloud. In some embodiments, an application 206a may be downloaded directly onto a device and application 206n communicates with application 206a via the network.

While illustrated in FIGS. 6A and 6B as groups of discrete components communicating with each other via distinct data signal connections, it will be understood that the present embodiments of the controller 46 are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

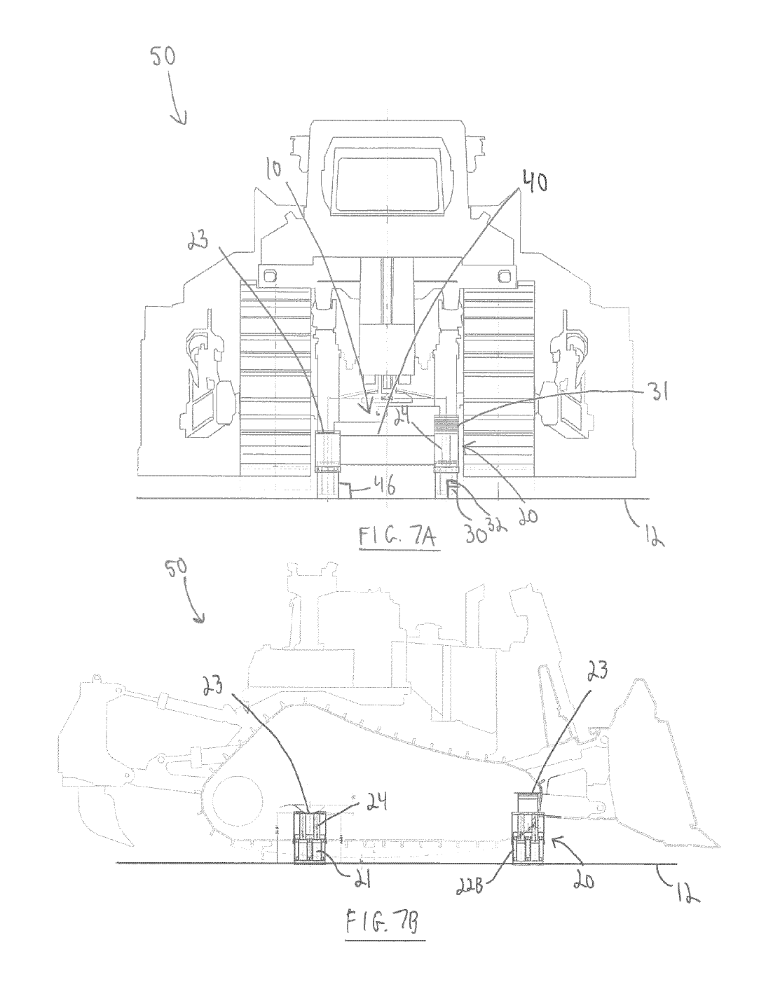

The lifting of the vehicle 50 is more easily appreciated with reference to FIGS. 7A and 7B. In operation, the application surfaces 23 of the lifting units 20 engage the lifting points 52 in order to apply the lifting force to displace the vehicle 50 upward with respect to the ground surface 12. Each cylinder 24 can apply the same lifting force as the other cylinders 24, or can apply a lifting force that varies among cylinders 24. Each cylinder 24 extends away from the lower portion 22B, typically a predetermined length. The predetermined length corresponds to the height to which it is desired to lift the vehicle 50. It is generally determined prior to commencing the lifting operation, and may be the only input provided to the lifting units 20. For example, an operator of the apparatus 10 may input a predetermined length of anywhere from 10 to 30 inches into the controller 46 for each of the lifting units 20. Other predetermined lengths are also possible. The cylinders 24 of each of the lifting units 20 will therefore have instructions to vertically extend as much as is required to raise the vehicle 50. The cylinders 24 of all of the lifting units 20 can be extended simultaneously to ensure the synchronised lifting of the vehicle 50.

Each of the lifting units 20 in FIGS. 7A and 7B is shown in a vertically extended position such that the vehicle 50 is no longer in contact with the ground surface 12. The extension of the cylinders 24, and thus the lifting operation (or the lowering of the vehicle 50, can be stopped for any reason prior to attaining the predetermined length. Indeed, the operator of the apparatus 10 is free to start and stop the extension of the cylinders 24 in an intermittent fashion. This may be desirable to assure a level lifting of the vehicle 50 in view of an uneven ground surface 12, or to redistribute loads between the lifting units 20, among other reasons. For example, the operator may intermittently control the extension of cylinders 24 in lifting units 20 disposed underneath left and right lifting points 52 of the vehicle 50. Such a precise control of the lifting units 20 helps to easily and quickly redistribute the load of the vehicle 50 between various lifting units 20, further contributing to the safety of the lifting/lowering operation performed by the apparatus 10.

Once the lifting units 20 have lifted the vehicle to the desired predetermined height, each lifting unit 20 will enter a hold configuration to maintain the vehicle in a raised position and to support its weight. A hydraulic locking device 30 helps to maintain the lifting units 20 in their extended position. The hydraulic locking device 30 can be any device or object which maintains the hydraulic fluid used to actuate the lifting units 20 within the lifting units 20. This helps to ensure that the pressure applied by the hydraulic fluid to drive the lifting units 20 and to maintain them extended remains in each lifting unit 20. In the event of a failure (e.g. hydraulic hose disconnect, loss of electrical current, etc.), the hydraulic locking device 30 therefore automatically shuts off the cylinder ports and ensures that hydraulic fluid will remain trapped inside the actuators 21, thus still safely supporting the load.

It can thus be appreciated that the apparatus 10 provides a hydraulic back up to help overall safety. Such a hydraulic back up can be more reliable and safer than certain mechanical locking systems, especially those used on bulldozers in the field, as these tend to jam from debris or dirt, or require a person to crawl underneath the raised bulldozer 50 to apply them. In contrast, the hydraulic locking device 30 is internal to the apparatus 10 and thus is not affected by dirt or debris, and does not require the intervention of any person to apply because it becomes operational automatically. It is also independent of any external components, such as hoses or cables.

The hydraulic locking device 30 in this embodiment consists of one or more counterbalance valves 32. The counterbalance valves 32, or holding valves, offer a relatively high level of hydraulic safety protection. Each counterbalance valve 32 can be part of a corresponding cylinder 24, and is a normally closed type of valve which will automatically shut off in case of a hydraulic leak or failure with the cylinders 24, thereby ensuring that oil remains trapped inside the hydraulic actuators 21 to maintain the cylinders 24 in their extended position. The counterbalance valves 32 therefore help to safely support the load while the leak or failure gets fixed. It will be appreciated that the unit of lifting force outputted by each of the lifting units 20 can include tons/tonnes, psi/Pa, lbs/N, etc.

In some embodiments, shims 31 may be placed between the output end of the cylinders 24 and the lifting points 52. If the weight of the vehicle 50 is known, the operator can determine the desired lifting force to be collectively applied by the lifting units 20, and input the lifting force value into the controller 46 (e.g. 500 tons). Alternatively, the weight may be input into the controller 46 and the lifting force may be determined by the controller 46 as a function of the weight and the height to which the vehicle 50 is to be lifted. The controller 46 may send lift signals to the lifting units 20 to command them to vertically extend their cylinders 24.

The vehicle 50 is now raised with respect to the ground surface 12, as shown in FIGS. 7A and 7B. The apparatus 10 allows work to be performed on both sides of the raised vehicle 50 simultaneously, and underneath the vehicle 50, which ultimately helps to lower the downtime of the vehicle 50.

Should any of the cylinders 24 or the lifting units 20 fail, the collective lifting force can be distributed amongst the lifting units 20 and cylinders 24 which remain functional. Alternatively, the controller 46 can signal the lifting units 20 to add more capacity because of their ability to collectively support the full weight of the vehicle 50. The linking beam 40 helps to ensure that the lifting operation remains balanced and stable. After maintenance has been performed on the vehicle 50, it can be lowered back to the ground surface 12. The controller 46 can command the lifting units 20 to steadily reduce the lifting force so that a controlled descent of the vehicle 50 can be achieved. The vehicle 50 can then be driven or towed off.

One or more pressure sensors may be provide on each lifting unit 20 to determine the lifting load at each lifting point. The pressure sensors are operatively connected to the controller 46.

There is also disclosed herein a method for lifting a heavy vehicle having lifting points from a ground surface. The method includes positioning each of a plurality of hydraulic lifting units underneath one of the lifting points, where each lifting unit has a common application surface being vertically displaceable by at least two extendible cylinders. The method also includes vertically extending the common application surface with the cylinders. The method also includes abutting the common application surface against the lifting point and applying a lifting force thereto to displace the vehicle upward from the ground surface.

It should be noted that the present invention can be carried out as a method, can be embodied in an apparatus, or can be provided on a computer readable medium having stored thereon program code executable by a processor. The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A heavy vehicle lifting apparatus, comprising:
a plurality of hydraulic lifting units each being positionable underneath a lifting point of the heavy vehicle and comprising:
a housing having a displaceable upper portion with an application surface being engageable with the lifting point; and
at least two hydraulic actuators disposed within the housing and linked with a common fixed structure, each actuator having an extendable cylinder attached to the upper portion, the cylinders in operation collectively vertically displacing the upper portion between a first position wherein the application surface is disengaged from the lifting point, and a second position wherein the application surface engages the lifting point and the heavy vehicle is lifted from a ground surface.

2. The lifting apparatus of claim 1, wherein the housing has a lower portion housing the at least two actuators, the upper portion of the housing mounted about the lower portion and being displaceable relative thereto.

3. The lifting apparatus of claim 2, wherein the lower portion includes a casing and the common fixed structure includes a base plate assembly and an upper plate assembly, the base plate assembly supporting a base of each actuator and being attached to the casing, the upper plate assembly having at least one opening therethrough and being attached to the casing, each cylinder being extendable through a corresponding opening in the upper plate assembly.

4. The lifting apparatus of claim 2, wherein the housing has at least one displacement guide disposed between an interior of the upper portion and an exterior of the lower portion.

5. The lifting apparatus of claim 4, wherein the at least one displacement guide includes a plurality of guidance plates, each guidance plate being attached to the interior of the upper portion, each guidance plate engaging the exterior of the lower portion to guide displacement of the upper portion relative thereto.

6. The lifting apparatus of claim 1, wherein the plurality of lifting units include a forward pair of lifting units and a rearward pair of lifting units.

7. The lifting apparatus of claim 1, further comprising a linking beam extending between at least two spaced-apart lifting units, opposed ends of the linking beam being attached to the housings of said lifting units.

8. The lifting apparatus of claim 7, wherein the opposed ends of the linking beam are attached to the upper portions of the lifting units and displaceable therewith.

9. The lifting apparatus of claims 7, wherein the opposed ends of the linking beam are attached to only the lifting units positionable underneath the lifting points of a rear of the heavy vehicle.

10. The lifting apparatus of claim 7, wherein the linking beam includes two support conduits mounted thereto, each support conduit being hollow to receive therein a lift member of a truck lift.

11. The lifting apparatus of claim 1, wherein at least one lifting unit includes a spacer box mounted to the application surface and displaceable therewith to engage a corresponding lifting point of the heavy vehicle.

12. The lifting apparatus of claim 11, wherein the spacer box is pivotally mounted to the application surface and pivotable relative thereto.

13. The lifting apparatus of claim 12, wherein the spacer box has an inner housing mounted to the application surface, and an outer housing pivotably mounted to the inner housing, the spacer box having a pivot rod connecting the inner and outer housings.

14. The lifting apparatus of claim 12, wherein the pivot rod extends along a pivot rod axis being perpendicular to a center axis of each cylinder, the pivot axis being disposed equidistantly between the center axes of the cylinders.

15. The lifting apparatus of claim 1, wherein at least one of the lifting units has at least one counterbalance valve, each counterbalance valve being operational between a normal configuration allowing a hydraulic fluid to enter and exit the hydraulic actuators of said lifting unit, and a hold configuration preventing the hydraulic fluid from exiting the hydraulic actuators.

16. The lifting apparatus of claim 1, wherein at least one of the lifting units has a displacement sensor, the displacement sensor having a transducer rod fixed to a base of said lifting unit and slidably disposed within at least one of the cylinders, the displacement sensor having a magnetic pick up adapted to track displacement of the cylinder relative to the transducer rod.

17. The lifting apparatus of claim 1, wherein at least one of the lifting units is supported by a platform being displaceable along the ground surface to be positioned underneath the lifting point.

18. The lifting apparatus of claim 1, wherein the cylinders of at least one lifting unit vertically displace the upper portion and the application surface a distance of between about 10 inches and about 30 inches.

19. The lifting apparatus of claim 1, wherein the application surfaces of the lifting units are engageable with lifting points disposed on a bulldozer or a truck.

20.-34. (canceled)

35. A method for lifting a heavy vehicle having lifting points from a ground surface, comprising:
positioning each of a plurality of hydraulic lifting units underneath one of the lifting points, each lifting unit having a common application surface being vertically displaceable by at least two extendible cylinders;
vertically extending the common application surface with the cylinders; and
abutting the common application surface against the lifting point and applying a lifting force thereto to displace the vehicle upward from the ground surface.

36.-46. (canceled)
